(19) United States
(12) Patent Application Publication
(10) Pub. No.: US 2004/0116141 A1
(43) Pub. Date: Jun. 17, 2004

(54) Resource management on a personal area network

(76) Inventors: Erick Loven, Urbana, IL (US); James Brennan, Urbana, IL (US); Michael Murphy, Champaign, IL (US)

Correspondence Address: MOTOROLA, INC., 1303 EAST ALGONQUIN ROAD, IL01/3RD, SCHAUMBURG, IL, 60196

(21) Appl. No.: 10/316,391

(22) Filed: Dec. 11, 2002

(51) Int. Cl. H04Q 7/20

(52) U.S. Cl. 455/519; 455/518

(57) ABSTRACT

A method for resource management in a personal area network includes providing (300) a plurality of communication devices with sharable resources on the personal area network. Each communication device has a resource manager able to communicate and manage the available resources of its resident device on the personal area network. Any one of the resource managers can be assigned (302) as a master resource manager for the personal area network to coordinate (308) information transfer and allocate available resources from the plurality of communication devices. The resources of each communication device is registered (304) in the personal area network with the master resource manager, which coordinates (308) information transfer with the devices when resources are requested (306) from the personal area network.

### FIELD OF THE INVENTION

The invention relates generally to methods and apparatus that provide communication over a wireless personal area network (PAN), and more particularly to methods and apparatus that provide management of communication over a wireless PAN.

### BACKGROUND OF THE INVENTION

Wireless communication units, such as radiotelephones, Internet appliances, personal digital assistants and other apparatus may communicate over a wide area network (WAN), such as a wireless cellular system or over a wireless link to an Internet point of presence. In addition, such wireless communication apparatus may also have a short-range wireless transceiver to allow wireless communication with other local devices that are close to one another. For example, Internet appliances may include a local area network communication mechanisms, such as a Bluetooth™ based transceiver, short range optical transceiver, or other short range transceiver that allows communication via a local area network with other wireless devices, such as printers, headsets, etc. Generally, the wireless air interface between a wireless communication unit and the wide area network and other local subscriber apparatus will be different. For example, common standardized cellular air interfaces include GSM, IS-95, IS-136 etc. Wireless LAN air interfaces include such things as Bluetooth™, IEEE 802.11, Hiperlan™, etc.

When implementing personal area networks, a means of allocating resources to instances of applications across the network of distinct devices must be provided. For example, a means of routing voice and data to the proper resources spread across the network of distinct devices must be provided. Resource management of multiple, distinct devices already exists for the fixed end phone and cellular networks. For example, trunked radio systems are able to determine what fixed resources are available to them. These resources can include, for example, what transmission channels are available, what consoles are available, what security modules are available, etc. However, this fixed resource management has not been done on small, personal devices using wireless technologies, and cannot account for wireless dynamics.

Another approach to resource management is the Bluetooth™ service discovery technique, wherein one device must query other devices for available resources. However, in this technique, the resources in the Bluetooth network are unknown unless a device is queried about its resources. Further, one resource manager is used to manage the available resources. This does not allow for easy adaptation to dynamic resource changes in the personal area network.

In addition, personal area networks tend to be very ad-hoc with different devices available for each user or perhaps for each connection. The problem is complicated where the power/battery life status of a distinct device impacts the allocation of resources for the instance of an application. A solution must be able to address a more random availability of devices than fixed end networks. For example, the on/off status of a distinct device requires a means of reflecting availability of applications dependent on resources only provided in that device, and a means of re-routing applications to resources in other devices.

Accordingly, a need exists for a technique for a user to define their own dynamic personal area network (PAN) incorporating devices operable on either or both of LAN and WAN networks. All of the resources in the personal area network should be able to be managed by the wireless devices themselves. It would also be of benefit for a device to determine what services/resources are available from other devices on the personal area network, and a means to request or receive updates on the availability of those services/resources. It would also be advantageous if a personal area network could provide a means of determining not only what devices/resources are present, but also characteristics of those devices/resources that help determine the most energy and/or cost efficient means of providing services.

### BRIEF DESCRIPTION OF THE DRAWINGS

The features of the present invention which are believed to be novel are set forth with particularity in the appended claims. The invention, together with further objects and advantages, may best be understood by reference to the following description taken in conjunction with the accompanying drawings, in the several figures of which reference numerals identify like elements, in which:

FIG. 1 is a block diagram illustrating one example of a system for managing resources in a personal area network, in accordance with one embodiment of the invention;

FIG. 2 is a graphical illustration of a setup menu to allow wireless resource sharing in accordance with one embodiment of the invention; and

FIG. 3 is a flow chart illustrating one method for managing resources in a personal area network, in accordance with one embodiment of the invention.

### DETAILED DESCRIPTION OF A PREFERRED EMBODIMENT OF THE INVENTION

The present invention provides a technique for all of the resources in a personal area network to be managed by the wireless devices themselves. Each device has the ability to determine what services/resources are available from other devices on the personal area network, and request or receive updates on the availability of those services/resources. In addition, each device has the ability of determining not only what devices/resources are present, but also characteristics of those devices/resources that help determine the most energy and/or cost efficient means of providing services.

In particular, each device in the personal area network will have a Resource Manager that will determine which resources in the personal area network are available and in-use. In particular, a resource manager of a device will search for an available network to link with and broadcast its resources to that network. One device in the personal area network will act as the master resource manager for the personal area network. The resource manager of each device will register their available resources, such as Bluetooth audio, display, memory, UMTS cellular, etc., with the master resource manager. The master resource manager will then define a table of resources available to the personal area network. This table can also incorporate all the necessary protocols to access any particular resource or device.

An application on any of the devices may request the resources it needs from the master resource manager. Therefore, if a user wishes to make a voice call, the master resource manager will allocate the necessary audio and cellular resources of the personal area network to the application. When the application has finished, the master resource manager will deallocate the resources. Assuming there are no resource conflicts in the system, multiple applications could run at the same time using different resources. For example, FM Stereo and UMTS Data Call could occur simultaneously within the personal area network.

The resource manager within each device can act as the master resource manager for the personal area network. A prioritized voting technique is used to determine which device's resource manager will be the master of the personal area network. This can occur upon establishment of the personal area network, upon an existing master resource manager leaving the personal area network, or if a new device having a higher master resource manager priority joins the personal area network and can act as master resource manager. For example, if the device acting as the master resource manager is powered off, the next device requesting resources will discover that the master resource manager is gone. A new master resource manager will then be selected from the remaining devices to continue the personal area network. Devices will have some type of configuration information that predisposes them towards being the master. For instance, a headset or speakerphone by itself may be a bad choice for master resource manager due to its limited resources and also due to its role, i.e. primarily an end-node I/O device. On the other hand, cellular phones, personal digital assistants (PDAs), and personal computers (PCs) all would make good master resource managers. Therefore, in the present invention, each wireless device includes a resource manager that is assigned a relative master resource manager priority, which can be used in voting to select a master resource manager of the personal area network.

In practice, a resource may not be always available, even if the associated device remains in the network. For example, a printer may be shared and therefore temporarily unavailable, or the power of a device could be running low. Therefore, when each device registers with the master resource manager, the availability time for each resource will be calculated by the distinct device's resource manager based on a time schedule or the current battery state of the device. The availability time will be updated with the master resource manager periodically to inform the master resource manager of resource lifespan. If the battery in the UMTS Cellular device is about to run out of power, or if the device is temporarily unavailable, the user may be informed prior to using that resource.

In a preferred embodiment, each device's resource manager will also register certain preference attributes for the available resource. The master resource manager will use the preference attribute when assigning resources for each application. For example, a Bluetooth headset may have the preference set for the audio resource, so that anytime the Bluetooth headset is available in the personal area network, the master resource manager will use it for all connections with an audio resource. These preference attributes may be user settable, or determined by the distinct devices. More preferably, the resource manager of each device can have additional characteristics to register with the master resource manager, such as relative cost of resources. These cost characteristics will be tied to the user preference attributes, so that a user can choose cheaper resources.

The present invention has the advantage of secure, self-managed personal area network, using a scalable and powerful mechanism to control all of the available resources within the personal area network. Placing a resource manager into each device ensures interoperability of all the devices for multiple, seamless use cases. In addition, having each of the distinct resource managers capable of acting as the master resource manager will ensure that the personal area network will operate well without requiring any one particular device to be present.

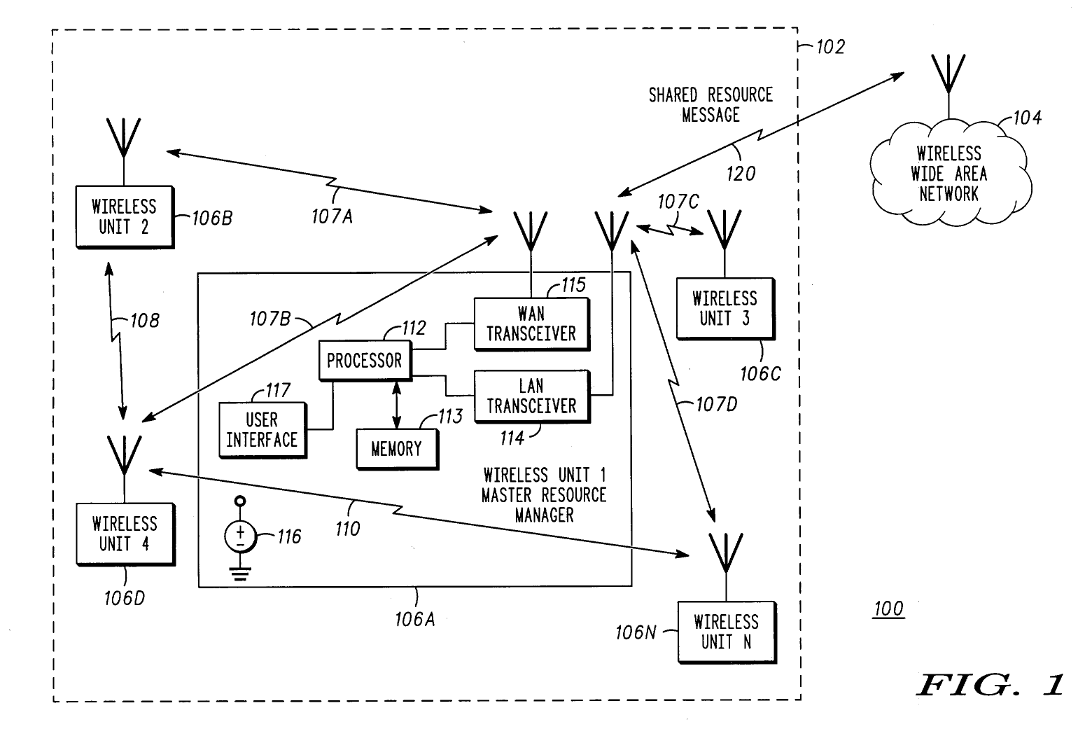

FIG. 1 is a block diagram illustrating resource management in a personal area network 100 that includes a wireless local area network (LAN) communication system 102, such as a short range wireless communication system compliant, for example, with the Bluetooth™ standard, or any other suitable short range communication protocol including, but not limited to, 802.11 or optical communication protocols. Optionally, the personal area network 100 can include a connection to a wireless wide area network (WAN) communication system 104, such as any one of the available cellular communication systems such as a CDMA or GSM communication system, a wireless link to the Internet, or any other suitable communication system. The wireless local area network communication system 102 portion of the personal area network includes a plurality of wireless units 106a-106n, such as a radiotelephone device, including, but not limited to, hand held apparatus, laptop computers, desk top computers, or any other suitable wireless communication device, and various wireless peripherals such as a printer, fax, headset, speakerphone, or any other device with a LAN transceiver.

Each of the wireless units 106a-106n includes a wireless local area network communication transceiver, such as a Bluetooth™-based transceiver, and can include a wireless wide area network transceiver, such as a CDMA cellular transceiver. Each of the wireless units can communicate in a peer-to-peer arrangement with each other using the wireless local area network communication transceivers, and those with a wireless wide area network transceiver can communicate individually with the wireless wide area network communication system 104. As illustrated, wireless units 106b-106n are operative to communicate using a wireless local area network protocol with wireless unit 106a via wireless LAN communication links 107a-107d. Wireless unit 106b and wireless unit 106d are in close enough proximity to allow communication between these two apparatus as shown by communication link 108. Similarly, wireless unit 106d and wireless unit 106n are also in close enough proximity to allow wireless local area network communication as illustrated by communication link 110. However, as shown, wireless unit 106c may not be within an acceptable proximity with wireless unit 106n to allow short-range communication between these two apparatus. Optionally, wireless unit 106a is in communication with the wireless wide area network 104 via link 120.

In this embodiment, each of the wireless units 106a-106n includes (as only shown in unit 106a for simplicity) a processor 112, such as a digital signal processor, microprocessor, discrete logic or any other suitable circuitry that can execute applications and includes a resource manager. For example, the resource manager of the processor 112 executes instructions that are stored in memory 113 that cause the processor 112 to, among other things, determine whether the resources of the wireless apparatus 106a are available to share with the wireless personal area network. The resource manager can also determine the life of a battery 116 of the unit, an operational status of the unit, and preferably the cost of use of the resource. All of this information is transferred through the LAN transceiver 114 (and/or optionally the WAN transceiver 115) to the master resource manager (in this case unit 106a) of the personal area network 100. Typically, the processor 112 of each unit is operatively coupled to a suitable user interface 117, in accordance with the particular operation of the unit, such as audio, visual, haptic, and mechanical user interface devices. In particular, these interface devices can be a display screen, keypad, speaker, microphone, voice recognition apparatus, or any other input apparatus associated with the particular resource of the unit.

In operation, the personal area network operates automatically, without user intervention, to provide optimal resource management. This automatic operation generally entails the resource manager of each unit periodically looking for one or more available personal area networks, and communicating with the master resource manager of the network so as to register its available resources on the personal area network. Additionally, the master resource manager can broadcast a message to any available units to register their resources with the network. The master resource manager then keeps a table of available resources in its memory for use by the personal area network as needed. This can all be accomplished autonomously, including selection of the master resource manager, as described previously. However, in some cases there may be a need for user intervention in the resource management of the personal area network. For example, if an application running on any unit of the personal area network requires a particular resource of some other unit, and there are found two units with the same available resource, or if there are no units with the resource, then a user can be asked to intervene to decide the proper course of action.

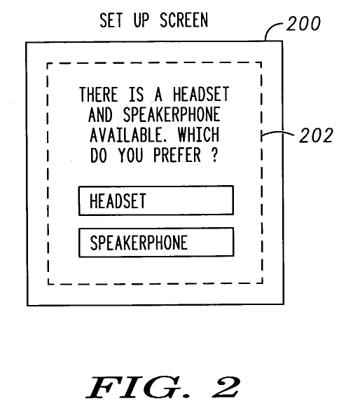

Referring to FIGS. 1 and 2, the processor 112 of the master resource manager is coupled to a display apparatus of a user interface 117 to allow the processor to provide a set up screen 200 which presents a user input interface having a selection menu 202 to generate a message that a user can use to select or prioritize the shared wireless personal area network resources within other proximal wireless units. In this example, a set up screen 200 is provided which includes the question, “There is a headset and speaker phone available. Which do you prefer?”. The user selects the “headset” or “speakerphone” button, which then generates a signal to the processor 112 indicating the resource selected. The processor 112 then generates a message (such as link 107a to wireless unit 106b for example) indicating that the wireless apparatus 106b will allow shared use of its resources by the application. Optionally, a button can be presented to prevent resource sharing of a particular resource (or in the case of no available resource) that directs the processor to ignore any I/O request of the application directed to the indicated resource. Preferably, this same screen set up can be used to prioritize resources when a personal area network is first established. In either case, the memory 113 is operatively coupled to processor 112 and includes executable instructions that when executed by the processor 112 causes the processor 112 to, among other things, direct the indicated unit to respond to the application I/O instruction either directly from the requesting device or relayed through the master resource manager. It should be recognized, however, that instead of the processor 112 executing instructions, any suitable hardware, combination of hardware, software and firmware could be utilized as desired. Accordingly, the processor 112 may control other circuits or processing devices to perform the operations set forth herein.

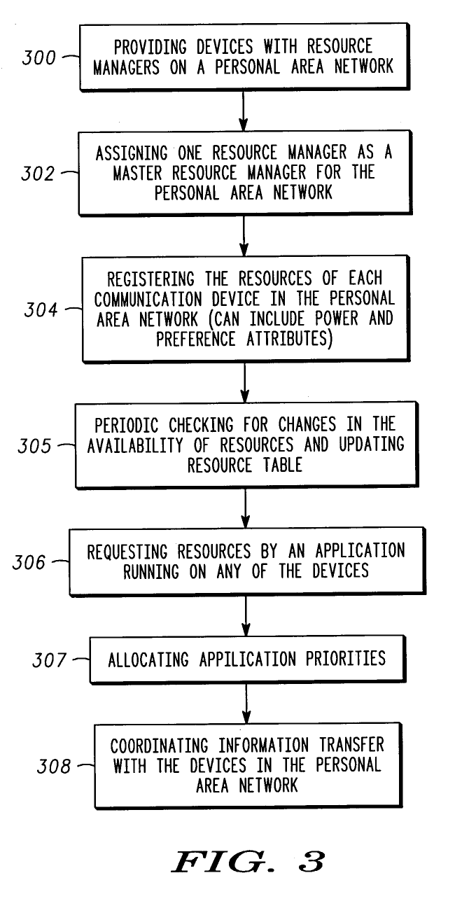

FIG. 3 is a flow chart illustrating a method of resource management of a personal area network, in accordance with one embodiment of the invention. The personal area network is operable on one or more of a wireless local area network (LAN) and a wireless wide area network (WAN). The method includes a first step 300 of providing a plurality of communication devices operable on the personal area network. Each communication device has resources sharable with the personal area network and a resource manager able to communicate and manage the available resources of its resident device on the personal area network. A next step 302 includes assigning one of the resource managers as a master resource manager for the personal area network to coordinate available resources from the plurality of communication devices. The master resource manager can be assigned: upon formation of the initial personal area network, upon the addition of a more suitable device into the personal area network, or upon an existing master resource manager leaving the personal area network. In any of these scenarios prioritized voting is used among the resource managers of the devices in the personal area network to determine which of them is assigned as master resource manager.

A next step 304 includes registering the resources of each communication device in the personal area network. This is done by each device in the personal area network broadcasting its resources to the master resource manager to be registered therewith. Registering is done automatically. However, in the case of resource conflicts, redundancies, power limitations, or other problems, this step 304 can include a setting of priorities or selection of resources. The processor, for example, can set up a user interface with a selection menu to allow selection or prioritization of resources available to the personal area network. Alternatively, the master resource manager can automatically select resources based on predetermined priorities or selection algorithm. Preferably, the registering step includes periodic checking 305 for changes in the availability of resources. In this way, the master resource manager of the network can update its resource table properly. To provide more seamless operation, the registering step can include registering an available power reserve of each device to store in the resource table of the master resource manager, such that the master resource manager can automatically re-route information away from those devices with limited power reserves. More preferably, the registering step includes registering a preference attribute of each device. Preference attributes can provide an initial priority of a resource to automatically resolve conflicts if other similar resources are available. Preferences can also be established between complimentary resources, such as a preferred earpiece to be used with a corresponding microphone. Further preference attributes can include cost and efficiency characteristics of a particular resource. The master resource manager can then take the preference attributes of a device into account when coordinating information transfer among available resources.

A next step 306 includes requesting resources from the master resource manager by an application running on any of the devices. It is envisioned that a requesting application would originate on the device of the master resource manager. However, any of the devices on the personal area network can originate an application. In such case, the resource manager of the particular device running the application requests, through the master resource manager, the necessary resources. It is also envisioned that, on occasion, there will be more than one application running on a personal area network. In this instance, there can arise conflicting demands for resources. Therefore, it is preferred that this step includes allocating 307 application priorities such that a new application can preempt resources from another application in accordance with the priority associated with the new application.

A next step 308 includes coordinating information transfer with the devices in the personal area network in accordance with their associated available resources. This coordination can be through the master resource manager, or can be directly between devices once the master resource manager establishes peer-to-peer resource protocols for an application. Given any change of status of a resource, loss of power, conflict, new application, etc., the resource manager can automatically re-route information to adapt to changes in the availability of resources.

It will be recognized that the local area network communication in the present invention can be an optical local area network as well as a radio frequency-based local area network or any other suitable or any other suitable wireless LAN. In this example, the wireless local area network can be any suitable short-range local area network as desired.

It is also understood that the wide area and local area communication to the individual communication devices might not be from the same networks. For example, one system may be a UMTS system to access particular data, while another system may utilize a GSM system. Similarly, different LAN systems can be utilized. It should be recognized that protocols can be in place to allow the desired connection between a communication device, a LAN, and a WAN, even if the subscriber does not have the capability to access a particular network.

As described herein, and as previously noted, each of the wireless communication devices can include a wireless wide area network transceiver and a wireless local area network transceiver along with a processing device that is operatively coupled to the wireless wide area network transceiver and to the wireless local area network transceivers wherein the processing device is operative to perform the above-identified operations. Accordingly, the processing devices may be programmed with executable instructions or applications that when executed cause the processing device or devices to perform the operations described herein.

It should be understood that the implementation of other variations and modifications of the invention in its various aspects will be apparent to those of ordinary skill in the art, and that the invention is not limited by the specific embodiments described. It is therefore contemplated to cover by the present invention, any and all modifications, variations, or equivalents that fall within the broad scope of the basic underlying principles disclosed and claimed herein.

What is claimed is:

1. A method for resource management in a personal area network, the method comprising the steps of:
providing a plurality of communication devices operable on the personal area network, each communication device having resources sharable with the personal area network and a resource manager able to communicate and manage the available resources of its resident device on the personal area network;
assigning one of the resource managers as a master resource manager for the personal area network to coordinate available resources from the plurality of communication devices;
registering the resources of each communication device by said device in the personal area network with the master resource manager; and
coordinating information transfer with the devices in the personal area network in accordance with their associated available resources.

2. The method of claim 1, wherein the personal area network is operable on one or more of a wireless local area network (LAN) and a wireless wide area network (WAN).

3. The method of claim 1, wherein the registering step includes periodic checking for changes in the availability of resources.

4. The method of claim 3, wherein the coordinating step includes automatically re-routing information to adapt to changes in the availability of resources.

5. The method of claim 1, wherein the registering step includes registering an available power reserve of each device, and wherein the coordinating step includes automatically re-routing information from those devices with limited power reserves.

6. The method of claim 1, wherein the registering step includes registering preference attribute of each device, and wherein the coordinating step takes the preference attributes of a device into account when coordinating information transfer.

7. The method of claim 6, wherein the registering step includes efficiency characteristics as one preference attribute, and wherein the coordinating step takes the efficiency characteristics into account when coordinating information transfer.

8. The method of claim 1, wherein the assigning step includes prioritized voting to determine which of the resource managers is assigned as master resource manager.

9. The method of claim 1, further comprising the step of requesting resources from the master resource manager by an application running on any of the devices.

10. A method for resource management in a personal area network operable on a wireless local area network (LAN) and a wireless wide area network (WAN), the method comprising the steps of:
providing a plurality of communication devices operable on the personal area network, each communication device having resources sharable with the personal area network and a resource manager able to communicate and manage the available resources of its resident device on the personal area network, any resource manager of an available device in the personal area network able to operable as a master resource manager of the personal area network;
assigning, using prioritized voting, one of the resource managers as a master resource manager for the personal area network to coordinate available resources from the plurality of communication devices;
registering the resources and operational status of each communication device by said device in the personal area network with the master resource manager;
requesting resources from the master resource manager by an application running on any of the devices; and
coordinating information transfer with the devices in the personal area network in accordance with their associated available resources, and re-routing information to adapt to changes in the availability of resources.

11. The method of claim 10, wherein the registering step includes registering an available power reserve of each-device, and wherein the coordinating step includes automatically re-routing information from those devices with limited power reserves.

12. The method of claim 10, wherein the operational status of the registering step includes preference attributes for the available resources of each device, and wherein the coordinating step takes the preference attributes into account when coordinating information transfer.

13. The method of claim 10, wherein the requesting step includes allocating application priorities, wherein in the coordinating step a new application can preempt resources from another application in accordance with the priority associated with the new application.

14. A system for managing communication on a personal area network, the system comprising:
a plurality of communication devices operable to communicate together, each communication device having resources sharable with the plurality of communication devices and a resource manager able to communicate and manage the available resources of its resident device with the personal area network;
a master resource manager for the personal area network, the master resource manager assigned from any one of the resource managers, the master resource manager operable to coordinate available resources from the plurality of communication devices for the personal area network; and
an application that requests resources on the personal area network from the master resource manager, which subsequently allocates the necessary resources.

15. The system of claim 14, wherein each resource manager is operable to register an operating status of its associated communication device to the master resource manager when the communication device is powered on.

16. The system of claim 14, wherein each resource manager is operable to communicate the available power of its associated communication device to the master resource manager.

17. The system of claim 14, wherein the master resource manager coordinates information transfer of the devices and allocates resources with the personal area network in accordance with each device's operational status and available resources.

18. The system of claim 14, wherein each resource manager is operable to communicate preference attributes of its associated communication device to the master resource manager, and wherein the master resource manager coordinates information transfer of the devices and allocates resources with the personal area network in accordance with preference attributes of each device.

19. The system of claim 14, wherein each resource manager is operable to communicate efficiency characteristics of its associated communication device to the master resource manager, and wherein the master resource manager coordinates information transfer of the devices and allocates resources with the personal area network in accordance with efficiency characteristics of each device.

20. The system of claim 14, wherein each of the resource managers can act as the master resource manager, which is chosen among the resource managers through prioritized voting.
